(19) United States
(12) Patent Application Publication
(10) Pub. No.: US 2012/0037481 A1
(43) Pub. Date: Feb. 16, 2012

(54) PRODUCTION-LINE DISTRIBUTION CONVEYOR SYSTEM AND RECIPROCATING CONVEYING PLATFORM THEREOF

(75) Inventors: Chengming He, Guangdong (CN); Changhung Pan, Guangdong (CN)

(73) Assignee: SHENZHEN CHINA STAR OPTOELECTRONICS TECHNOLOGY CO., LTD., Shenzhen (CN)

(21) Appl. No.: 12/996,130

(22) PCT Filed: Aug. 12, 2010
(86) PCT No.: PCT/CN10/75922

§ 371 Date: Dec. 3, 2010

(51) Int. Cl. B65G 47/46

(52) U.S. Cl. 198/890.1

(57) ABSTRACT

The present invention provides a production-line distribution conveyor system and a reciprocating conveying platform. The production-line distribution conveyor system has a front delivery end, two rear delivery ends and a reciprocating conveying platform. The reciprocating conveying platform is disposed between the front delivery end and the rear delivery ends, and has two transport mechanisms which are disposed side by side and corresponding to the rear delivery ends, respectively. When the reciprocating conveying platform reciprocally shifts, the two transport mechanisms receive work-pieces by turns and convey the received works-pieces to the corresponding rear delivery end by turns. Since the two transport mechanisms can separately perform a process of conveying one work-piece and a process of receiving another work-piece during a reciprocal shifting movement of the reciprocating conveying platform, the production-line distribution efficiency can be increased.

### FIELD OF THE INVENTION

The present invention relates to a production-line distribution conveyor system and a reciprocating conveying platform thereof, and more particularly to a production-line distribution conveyor system that effectively increases the production-line distribution efficiency and a reciprocating conveying platform thereof.

### BACKGROUND OF THE INVENTION

Nowadays, high-technology industries have designed a conveyor system that conveys work-pieces from a single-path conveyor line to a dual-path conveyor line, in order to increase production capacity for production lines of finished or semi-finished work-pieces of flat panel displays. With reference to FIGS. 1A to 1D, a schematic view of distribution actions of a conventional production-line distribution system is disclosed, and has a front delivery end 90, two rear delivery ends 91 and a reciprocating conveying platform 92. The front delivery end 90 is loaded with a plurality of work-pieces 81-83 waiting to be distributed, such as liquid crystal displays. The two rear deliver ends 91 are arranged side by side and defined as a first rear delivery end 910 and a second delivery end 911. The reciprocating conveying platform 92 is disposed between the front delivery end 90 and the two rear delivery ends 91, and reciprocally shifts in a direction perpendicular to a conveying direction of the front delivery end 90.

With further reference to FIG. 2, the reciprocating conveying platform 92 has a transport mechanism. The transport mechanism has a plurality of rollers 920 forming a conveying plane. With reference to FIG. 1A, after receiving a work-piece 81, the reciprocating conveying platform 92 shifts to a position in front of the first rear delivery end 910 and conveys the work-piece 81 to the first rear delivery end 910. The reciprocating conveying platform 92 then shifts back to a position in front of the front delivery end 90, continues to receive next work-piece 82, and then shifts to a position in front of the second delivery end 911 to convey the work-piece 82 thereto. After this, the reciprocating conveying platform 92 shifts back to the position in front in front of the front delivery end 90 to continue to receive next work-piece 83 to start another cycle.

However, such production-line distribution system has a problem on slow speed conveying. This is because the reciprocating conveying platform 93 only receives one work-piece 81 from the front delivery end 90 once at a time; next work-piece 82 has to wait to be received by the reciprocating conveying platform 92 until the previous work-piece 81 is conveyed out of the reciprocating conveying platform 92. Therefore, the production speed of the whole production line is inevitably lowered and leads to low production capacity.

Hence, it is necessary to provide a production-line distribution conveyor system and a reciprocating conveying platform thereof to overcome the problems existing in the conventional technology.

### SUMMARY OF THE INVENTION

A primary object of the invention is to provide a production-line distribution conveyor system which comprises a reciprocating conveying platform having two transport mechanisms that work independently of each other, wherein when one of the transport mechanisms conveys a work-piece, the other one is able to receive another work-piece at the same time, so as to effectively facilitate production-line distribution to enhance distribution efficiency for increasing production capacity.

A secondary object of the present invention is to provide a reciprocating conveying platform which has two transport mechanisms that work independently of each other. When the reciprocating conveying platform is applied to a production-line distribution conveyor system, the two transport mechanisms can simultaneously convey one work-piece and receive another work-piece, respectively, and thereby effectively enhance production-line distribution efficiency.

To achieve the above object, the present invention provides a production-line distribution conveyor system which comprises:

a front delivery end;

a first rear delivery end having a conveying direction parallel to a conveying direction of the front delivery end;

a second rear delivery end having a conveying direction parallel to the conveying direction of the front delivery end, wherein the second rear delivery end is disposed side-by-side with the first rear delivery end; and

a reciprocating conveying platform disposed between the front delivery end and the first and second rear delivery ends, and shifts in a shifting direction perpendicular to the conveying direction of the front delivery end; wherein the reciprocating conveying platform has a first transport mechanism and a second transport mechanism corresponding to the first and second delivery ends, respectively, for conveying work-pieces; wherein when the first transport mechanism corresponds to the first rear delivery end and conveys a first work-piece thereto, the second transport mechanism corresponds to the front delivery end and receives a second work-piece therefrom; when the first transport mechanism corresponds to the front delivery end and receives a third work-piece therefrom, the second transport mechanism corresponds to the second rear delivery end and conveys the second work-piece thereto.

Furthermore, the present invention provides a reciprocating conveying platform for a production-line distribution conveyor system, disposed between a front delivery end and both of a first rear delivery end and a second rear delivery end disposed side by side. The reciprocating conveying platform has a first transport mechanism and a second transport mechanism corresponding to the first and second delivery ends, respectively, for conveying work-pieces; wherein when the first transport mechanism corresponds to the first rear delivery end and conveys a first work-piece thereto, the second transport mechanism corresponds to the front delivery end and receives a second work-piece therefrom; when the first transport mechanism corresponds to the front delivery end and receives a third work-piece therefrom, the second transport mechanism corresponds to the second rear delivery end and conveys the second work-piece thereto.

In one embodiment of the present invention, each of the first and the second transport mechanisms has a plurality of rollers, wherein the rollers form a conveying plane, and the conveying plane has a conveying direction parallel to the conveying directions of the front delivery end and the first and second rear delivery ends.

In one embodiment of the present invention, the front delivery end is an output end of a conveyor belt.

In one embodiment of the present invention, the first rear delivery end and the second rear delivery end are two input ends of two rear conveyor belts disposed side by side.

In one embodiment of the present invention, the reciprocating conveying platform has a size larger than a size of the two work-pieces disposed side by side, and the first transport mechanism and the second transport mechanism are independent of each other and disposed side by side.

In one embodiment of the present invention, each of the work-pieces is a finished or semi-finished product of flat panel display, such as a liquid crystal panel, a liquid crystal module or a backlight module.

Comparing to the existing technology, the production-line distribution conveyor system and a reciprocating conveying platform of the present invention enhance production-line distribution efficiency and make production capacity of production line to have significant improvement.

### DESCRIPTION OF THE DRAWINGS

FIGS. 1A to 1D are schematic views of distribution actions of a conventional production-line distribution system;

FIG. 2 is a top view of a conventional reciprocating conveying platform applied to FIG. 1;

FIGS. 3A to 3C are schematic views of distribution actions of a production-line distribution conveyor system according to a preferred embodiment of the present invention;

FIG. 4 is a top view of a reciprocating conveying platform according to a preferred embodiment of the present invention;

FIGS. 5A to 5H are schematic views of detail distribution actions of the production-line distribution conveyor system of the present invention; and

FIGS. 6A to 6H are schematic views of detail distribution actions of the conventional conveyor system.

### DETAILED DESCRIPTION OF THE PREFERRED EMBODIMENTS

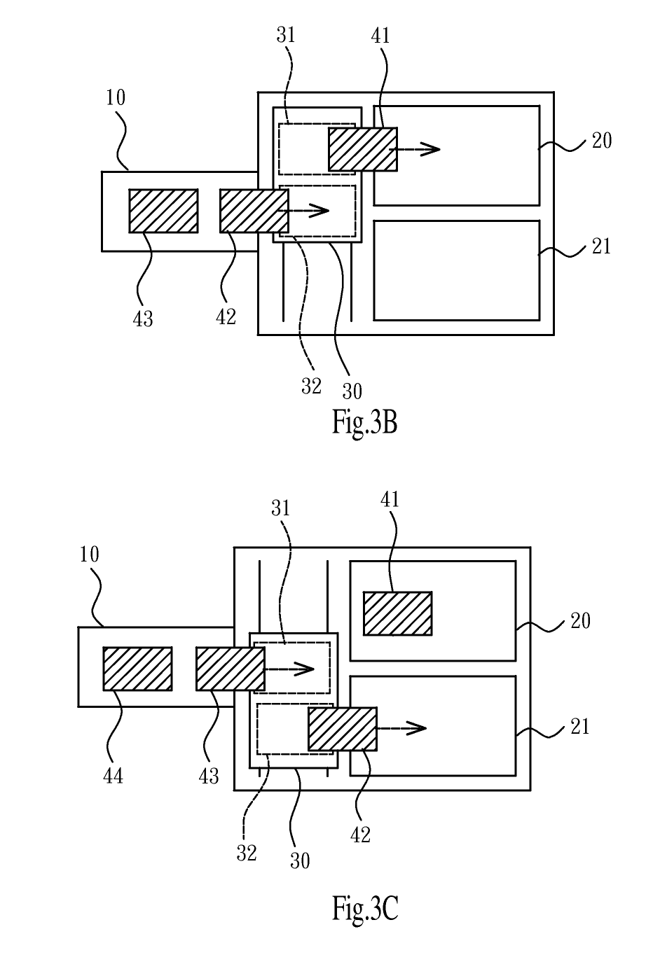

With reference to FIGS. 3A to 3C, schematic views of distribution actions of a production-line distribution conveyor system according to a preferred embodiment of the present invention are illustrated, wherein the production-line distribution conveyor system comprises a front delivery end 10, a first rear delivery end 20, a second rear delivery end 21 and a reciprocating conveying platform 30. The foregoing components of the present invention will be described more detailed hereinafter.

With reference to FIGS. 3A to 3C, in a preferred embodiment of the present invention, the front delivery end 10 is an output end of a conveyor belt. The front delivery end 10 can be loaded with a plurality of work-pieces 41-43 waiting to be conveyed. Each of the work-pieces 41-44 can be a finished or semi-finished product of various electronic products, preferably a finished or semi-finished product of flat panel display, such as a liquid crystal panel, a liquid crystal module or a backlight module.

With reference to FIGS. 3A to 3C, in a preferred embodiment of the present invention, the first rear delivery end 20 and the second rear delivery end 21 are two input ends of two rear conveyor belts disposed side by side for receiving the distributed work-pieces 41-43, respectively.

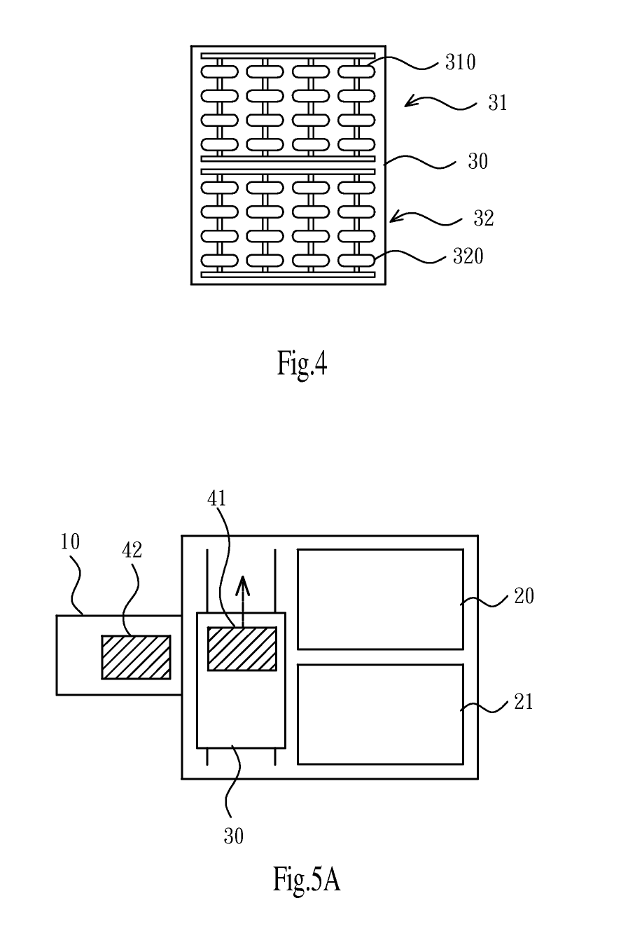

With reference to FIGS. 3A to 3C and 4, FIG. 4 is a top view of a reciprocating conveying platform according to a preferred embodiment of the present invention. The reciprocating conveying platform 30 of the preferred embodiment of the present invention is disposed between the front delivery end 10 and the first and second rear delivery ends 20, 21. The reciprocating conveying platform 30 can be controlled to reciprocally shift between the front delivery end 10 and the first and second rear delivery ends 20, 21. The reciprocating conveying platform 30 shifts in a shifting direction perpendicular to the conveying direction of the front delivery end 10. The reciprocating conveying platform 30 reciprocally shifts to convey the work-pieces 41-43 from the front delivery end 10 to the first rear delivery end 20 and the second rear delivery end 21 in turn, respectively. In the present invention, the reciprocating conveying platform 30 has a size larger than a size of two of the work-pieces 41-42 disposed side by side. The reciprocating conveying platform 30 has a first transport mechanism 31 and a second transport mechanism 32. The first transport mechanism 31 and the second transport mechanism 32 are independent of each other and disposed side by side. The first transport mechanism 31 and the second transport mechanism 32 are disposed along a disposed direction parallel to a disposing direction of the first rear delivery end 20 and the second rear delivery end 21, so as to correspond to the first delivery end 20 and the second delivery end 21, respectively.

Furthermore, with reference to FIG. 4, the first transport mechanism 31 has a plurality of rollers 310, wherein the rollers 310 form a conveying plane which has a conveying direction parallel to the conveying directions of the front delivery end 10, the first rear delivery end 20 and the second rear delivery end 21. Similarly, the second transport mechanism 32 has a plurality of rollers 320, wherein the rollers 320 of the second transport mechanism 32 form a conveying plane which also has a conveying direction parallel to the conveying directions of the front delivery end 10, the first rear delivery end 20 and the second rear delivery end 21. During the reciprocal shifting movement of the reciprocating conveying platform 30, the first transport mechanism 31 and the second transport mechanism 32 receive the work-pieces 41-43 from the front delivery end 10 by turns and convey the work-pieces 41-43 to the corresponding first rear delivery end 20 and the second delivery end 21 by turns.

More specifically, with reference to FIGS. 3A to 3C, after the first transport mechanism 31 receives the work-piece 41, the reciprocating conveying platform 30 shifts toward a position in front of the first rear delivery end 20, so that the first transport mechanism 31 can correspond to the first rear delivery end 20 and convey the work-piece 41 thereto. In the meantime, position of the second transport mechanism 32 just corresponds to the position of the front delivery end 10 for receiving the work-piece 42. After the reciprocating conveying platform 30 then shifts toward a position in front of the second rear delivery end 21, the second transport mechanism 32 can correspond to the second rear delivery end 21 and convey the work-piece 42 thereto. In the meantime, position of the first transport mechanism 31 just corresponds to the position of the front delivery end 10 for receiving the work-piece 43 and then starts another conveying cycle.

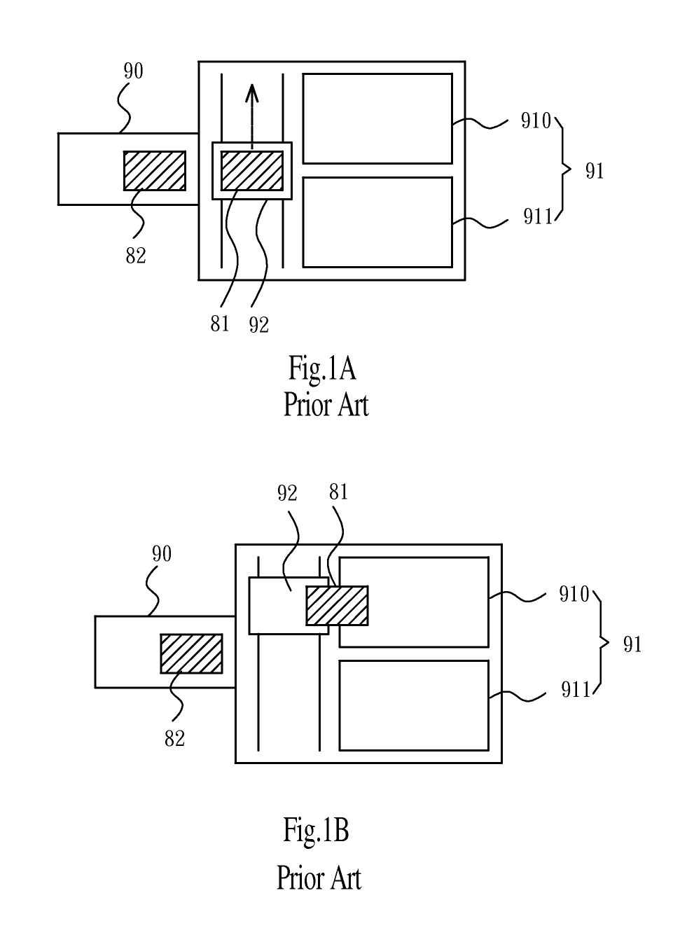

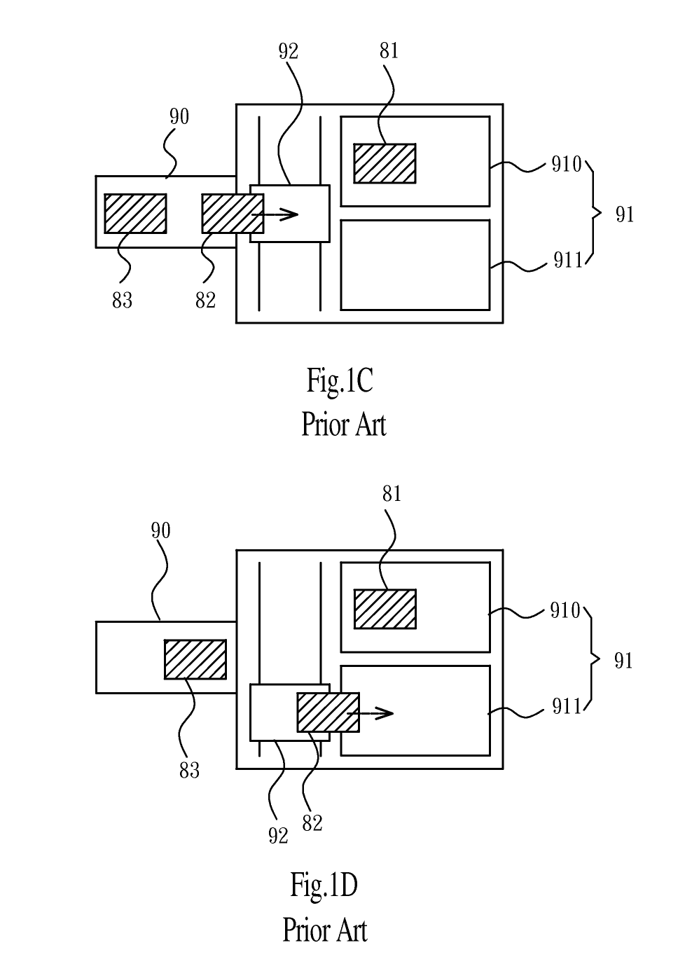

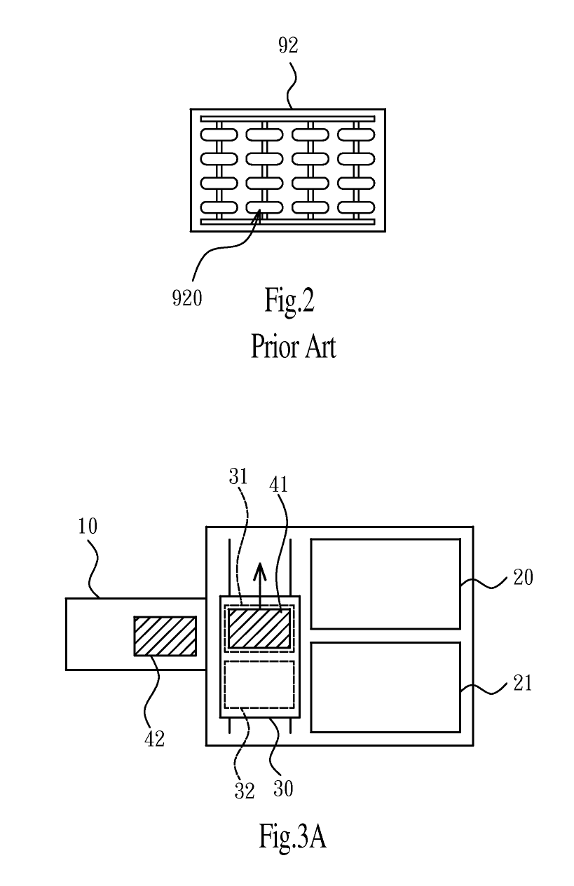

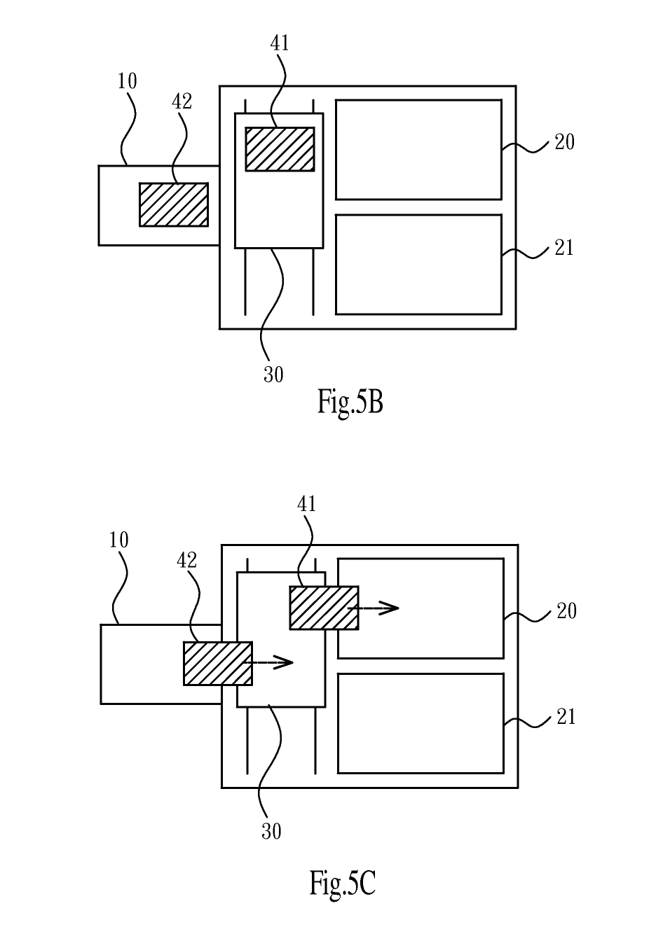

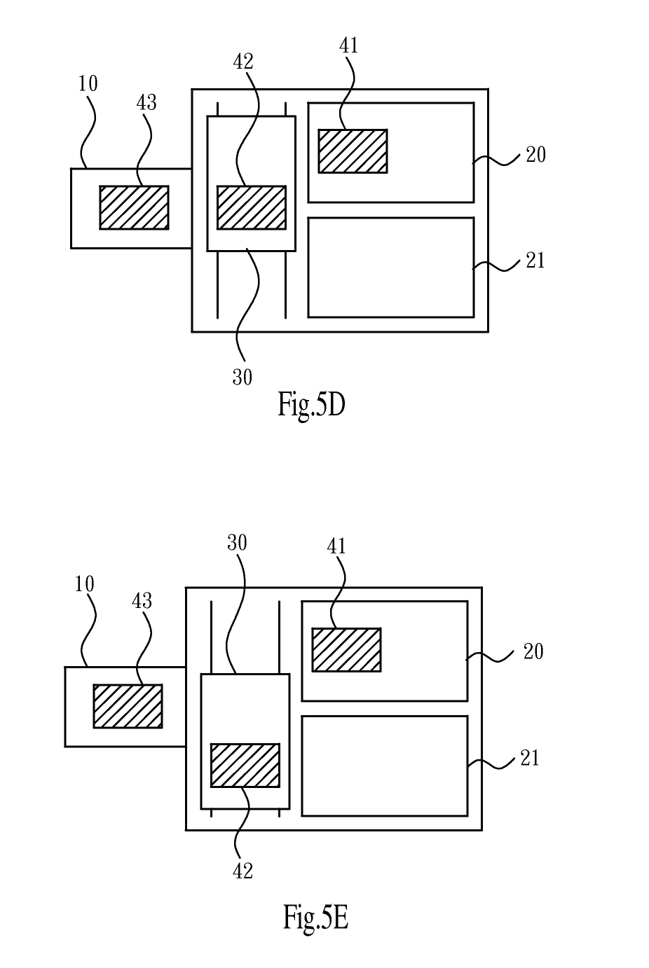

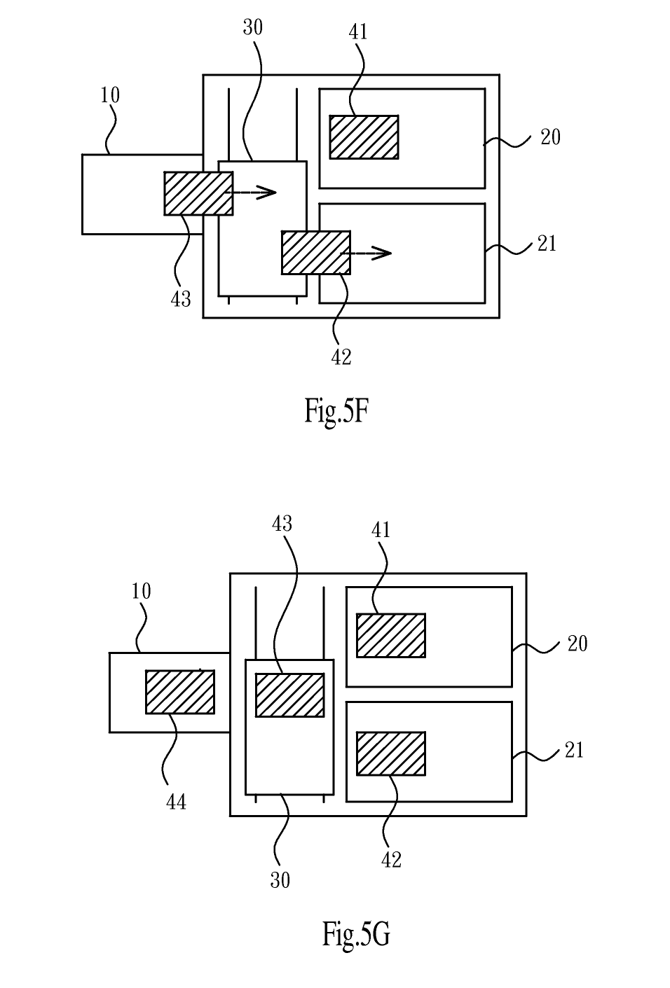

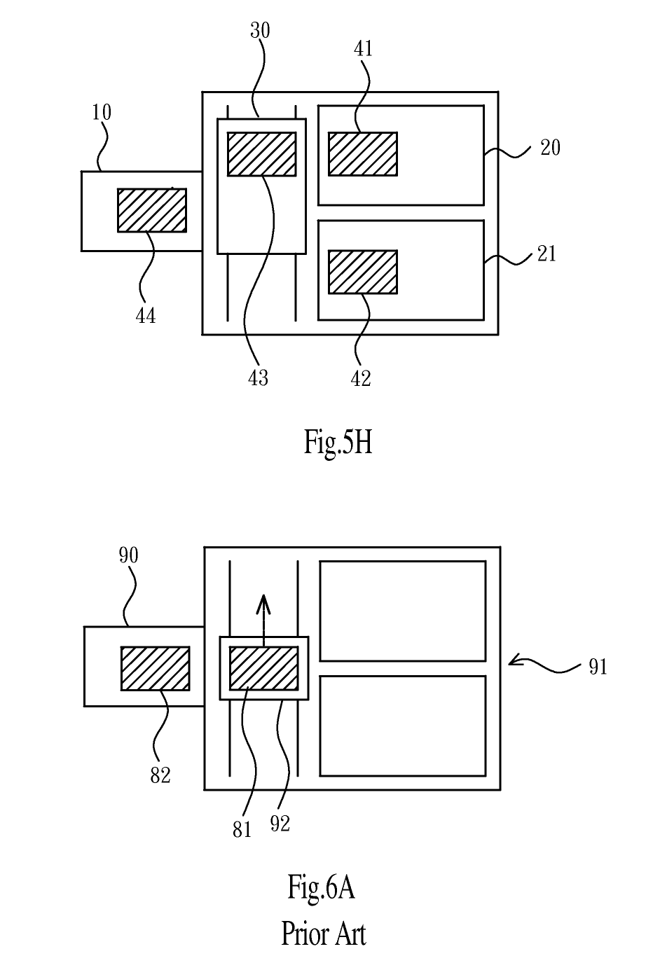

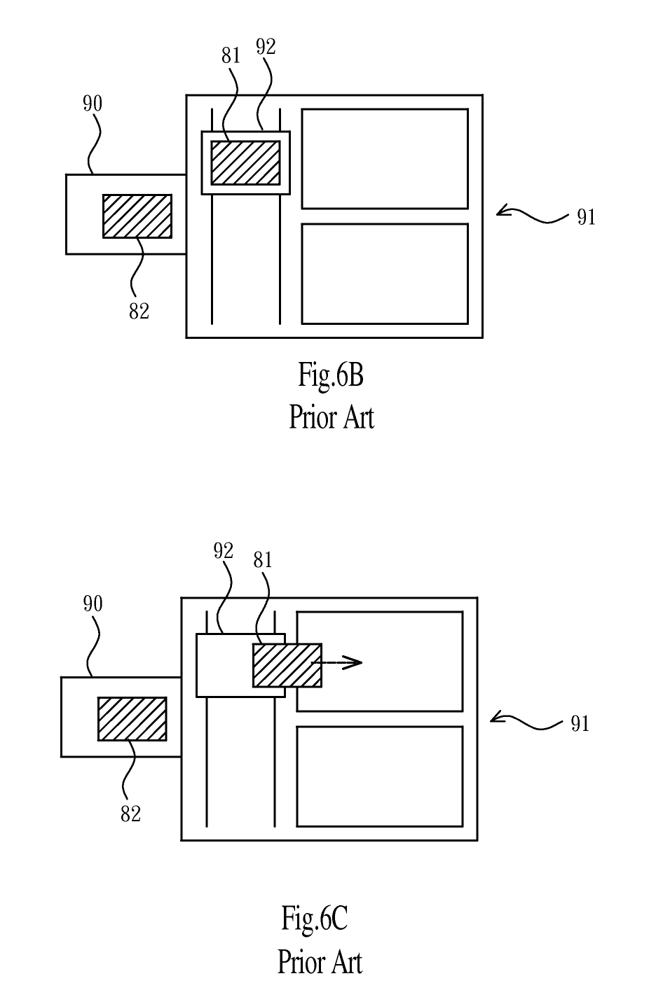

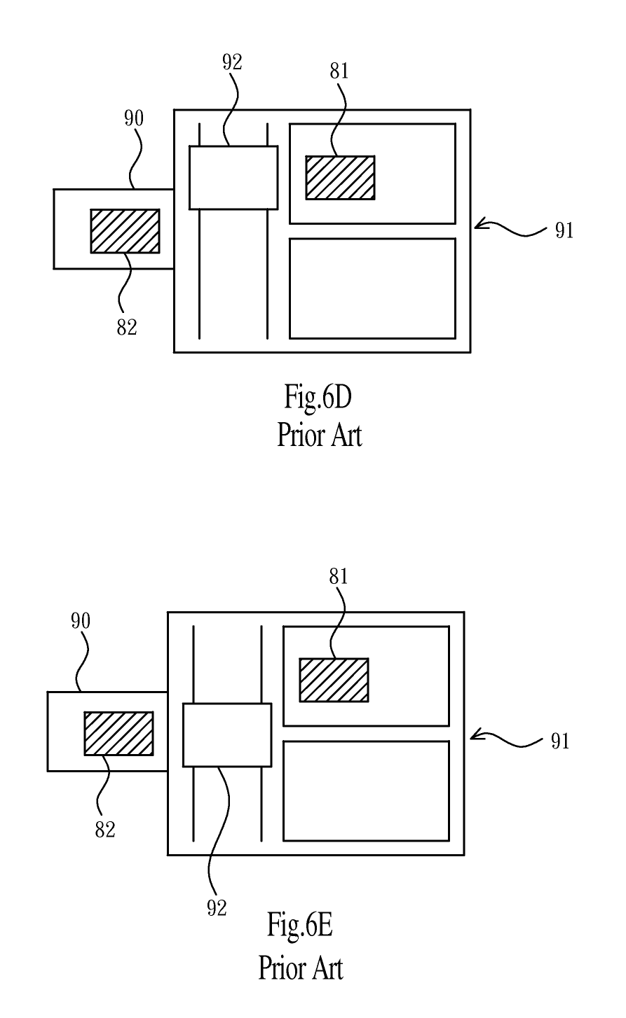

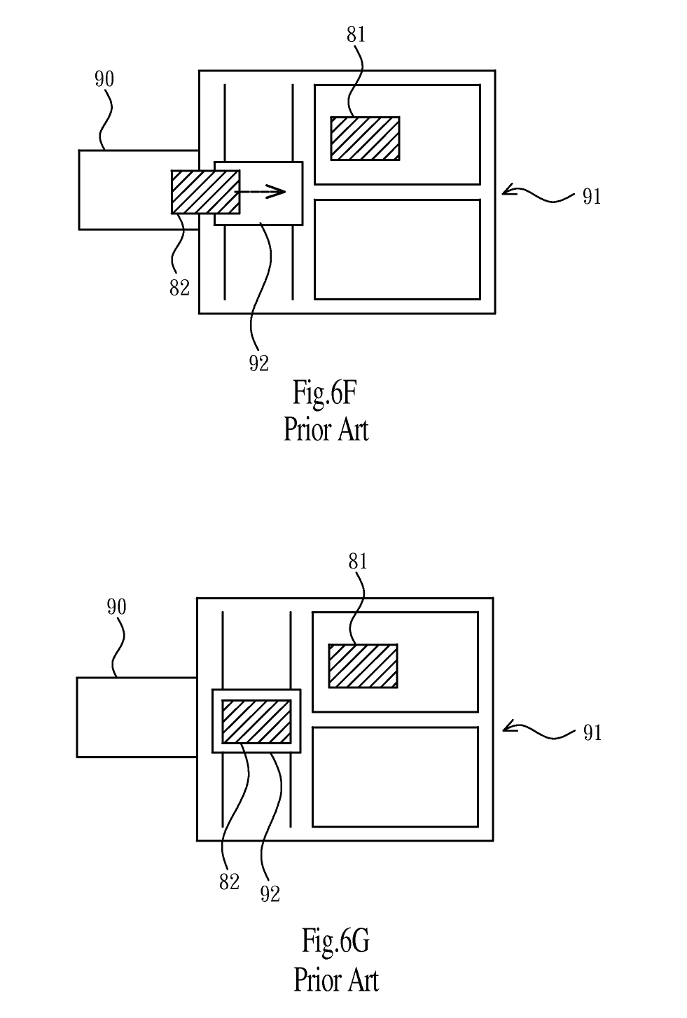

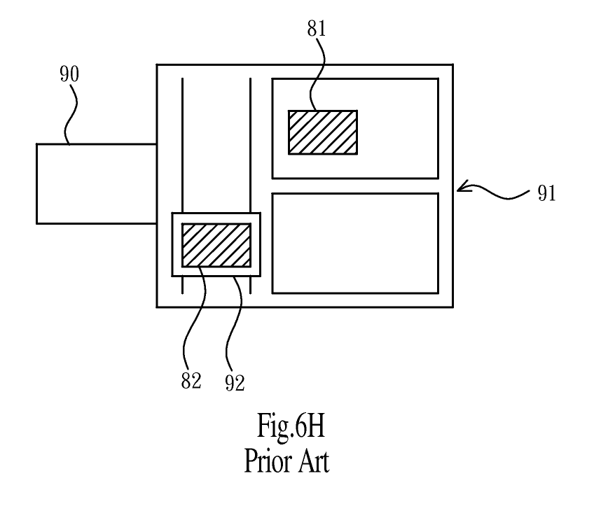

With further reference to FIGS. 5A to 5H and 6A to 6H, FIGS. 5A to 5H are schematic views of detail distribution actions of the production-line distribution conveyor system of the present invention, and each of figures is similar to FIGS. 3A to 3C, so as to use similar terms and numerals thereof. Besides, FIGS. 6A to 6H are schematic views of detail distribution actions of the conventional conveyor system, and each of figures is similar to FIGS. 1A to 1D, so as to use similar terms and numerals thereof.

Firstly, comparing FIGS. 5A to 5H with FIGS. 6A to 6H, respectively, FIGS. 5A to 5C disclose a process of conveying a work-piece 41 using the production-line distribution conveyor system in accordance with the present invention; FIGS. 6A to 6C disclose a process of conveying a work-piece 81 using a conventional conveyor system. Comparing FIG. 5C with FIG. 6C, it shows that both of the production-line distribution conveyor systems of the present invention and conventional skill perform the process of conveying work-piece 41, 81. However, the present invention further performs a process of receiving another work-piece 42 before performing the process of outputting the work-piece 41.

Then, FIGS. 5D to 5F disclose a process of conveying the work-piece 42 using the production-line distribution conveyor system in accordance with the present invention. Before the process of outputting the work-piece 42, the present invention further performs a process of simultaneously receiving still another work-piece 43 (FIG. 5F). In comparison with the present invention, the conventional conveyor system was just performing a process of receiving work-piece 82 (FIGS. 6D to 6F), but does not finish performing a process of outputting the work-piece 82.

Moreover, in FIGS. 5G to 5H, the production-line distribution conveyor system of the present invention already finished distributing the work-pieces 41, 42, and started another same cycle to convey the work-piece 43. In the meantime, the conveyor system of the conventional skill was still performing a process of conveying the work-piece 82 (FIGS. 6G to 6H). Therefore, the comparison shows the production-line distribution conveyor system of the present invention has a distribution efficiency better than that of the conventional production-line distribution conveyor system.

In conclusion, comparing with the reciprocating conveying platform of the conventional production-line distribution conveyor system having only one single transport mechanism which needs to fully perform a process of receiving and conveying a work-piece, then to perform another process of receiving and conveying next work-piece and thus lead to an un-desired distribution efficiency and lowering production capacity of production line, the production-line distribution conveyor system of the present invention as shown in FIGS. 3A to 3C and 4 uses the reciprocating conveying platform 30 having two independently-worked transport mechanisms 31, 32 to simultaneously perform a process of conveying one work-piece 41 and a process of receiving another work-piece 42 in one shifting movement cycle, which can effectively increase distribution efficiency for enhancing production capacity.

The present invention has been described with a preferred embodiment thereof and it is understood that many changes and modifications to the described embodiment can be carried out without departing from the scope and the spirit of the invention that is intended to be limited only by the appended claims.

1. A production-line distribution conveyor system comprises:
a front delivery end;
a first rear delivery end having a conveying direction parallel to a conveying direction of the front delivery end;
a second rear delivery end having a conveying direction parallel to the conveying direction of the front delivery end, wherein the second rear delivery end is disposed side-by-side with the first rear delivery end; characterized in that: the production-line distribution conveyor system further comprises:
a reciprocating conveying platform disposed between the front delivery end and the first and second rear delivery ends, and shifting in a shifting direction perpendicular to the conveying direction of the front delivery end; wherein the reciprocating conveying platform has a size larger than a size of two work-pieces disposed side by side, and the reciprocating conveying platform has a first transport mechanism and a second transport mechanism, the first transport mechanism and the second transport mechanism are independent of each other, disposed side by side, and corresponding to the first and second delivery ends, respectively, for conveying the work-pieces; wherein each of the first transport mechanism and the second transport mechanism has a plurality of rollers which form a conveying plane, and the conveying plane has a conveying direction parallel to the conveying directions of the front delivery end, the first and the second rear delivery ends;
wherein when the first transport mechanism corresponds to the first rear delivery end and conveys a first work-piece thereto, the second transport mechanism corresponds to the front delivery end and receives a second work-piece therefrom; when the first transport mechanism corresponds to the front delivery end and receives a third work-piece therefrom, the second transport mechanism corresponds to the second rear delivery end and conveys the second work-piece thereto.

2. A production-line distribution conveyor system comprises:
a front delivery end;
a first rear delivery end having a conveying direction parallel to a conveying direction of the front delivery end;
a second rear delivery end having a conveying direction parallel to the conveying direction of the front delivery end, wherein the second rear delivery end is disposed side-by-side with the first rear delivery end; characterized in that: the production-line distribution conveyor system further comprises:
a reciprocating conveying platform disposed between the front delivery end and the first and second rear delivery ends, and shifting in a shifting direction perpendicular to the conveying direction of the front delivery end; wherein the reciprocating conveying platform has a first transport mechanism and a second transport mechanism corresponding to the first and second delivery ends, respectively, for conveying work-pieces;
wherein when the first transport mechanism corresponds to the first rear delivery end and conveys a first work-piece thereto, the second transport mechanism corresponds to the front delivery end and receives a second work-piece therefrom; when the first transport mechanism corresponds to the front delivery end and receives a third work-piece therefrom, the second transport mechanism corresponds to the second rear delivery end and conveys the second work-piece thereto.

3. The production-line distribution conveyor system as claimed in claim 2, characterized in that: each of the first transport mechanism and the second transport mechanism has a plurality of rollers, wherein the rollers form a conveying plane, and the conveying plane has a conveying direction parallel to the conveying directions of the front delivery end, the first and second rear delivery ends.

4. The production-line distribution conveyor system as claimed in claim 2, characterized in that: the front delivery end is an output end of a conveyor belt.

5. The production-line distribution conveyor system as claimed in claim 2, characterized in that: the first rear delivery end and the second rear delivery end are two input ends of two rear conveyor belts disposed side by side.

6. The production-line distribution conveyor system as claimed in claim 2, characterized in that: the reciprocating conveying platform has a size larger than a size of two of the work-pieces disposed side by side, and the first transport mechanism and the second transport mechanism are independent of each other and disposed side by side.

7. A reciprocating conveying platform for a production-line distribution conveyor system, disposed between a front delivery end and both of a first rear delivery end and a second rear delivery end disposed side by side, characterized in that: the reciprocating conveying platform comprises a first transport mechanism and a second transport mechanism corresponding to the first and second delivery ends, respectively, for conveying work-pieces;
wherein when the first transport mechanism corresponds to the first rear delivery end and conveys a first work-piece thereto, the second transport mechanism corresponds to the front delivery end and receives a second work-piece therefrom; when the first transport mechanism corresponds to the front delivery end and receives a third work-piece therefrom, the second transport mechanism corresponds to the second rear delivery end and conveys the second work-piece thereto.

8. The reciprocating conveying platform for a production-line distribution conveyor system as claimed in claim 7, characterized in that: each of the first and the second transport mechanisms has a plurality of rollers, wherein the rollers form a conveying plane, and the conveying plane has a conveying direction parallel to the conveying directions of the front delivery end, the first and second rear delivery ends.

9. The reciprocating conveying platform for a production-line distribution conveyor system as claimed in claim 7, characterized in that: the front delivery end is an output end of a conveyor belt.

10. The reciprocating conveying platform for a production-line distribution conveyor system as claimed in claim 7, characterized in that: the first rear delivery end and the second rear delivery end are two input ends of two rear conveyor belts disposed side by side.

11. The reciprocating conveying platform for a production-line distribution conveyor system as claimed in claim 7, characterized in that: the reciprocating conveying platform has a size larger than a size of two of the work-pieces disposed side by side, and the first transport mechanism and the second transport mechanism are independent of each other and disposed side by side.
